(19) United States
(12) Patent Application Publication
(10) Pub. No.: US 2006/0000563 A1
(43) Pub. Date: Jan. 5, 2006

(54) Elevator doorway door apparatus

(76) Inventor: Hisato Ito, Kiyose-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/218,469

(22) Filed: Sep. 6, 2005

Related U.S. Application Data
(63) Continuation of application No. PCT/JP04/05252, filed on Apr. 13, 2004.

(30) Foreign Application Priority Data
Aug. 8, 2003 (JP) 2003-206955

(51) Int. Cl. E05F 11/00

(52) U.S. Cl. 160/193

(57) ABSTRACT

In an elevator doorway door apparatus of a multi-speed type, a plurality of door panels are displaced forwardly and backwardly each other, and are movably supported in a transverse direction. During door closing, these door panels are arranged in an uneven step shape at the left and right, and an elevator doorway is closed. During door opening, the door panels move at different speeds in one direction toward the side of a door bag portion, and the doorway is opened. A closing member having a sealing material is provided at a side portion of one door panel with a high movement speed, and only during door closing, the closing member is brought into contact with a side portion of the other door panel to close a gap between the side portions. In this manner, the air tightness between the side portions of the door panels during door closing is well maintained without degrading the movement performance of the door panels, making it possible to enhance the noise shutout property and smoke shutout property.

### CROSS-REFERENCE TO RELATED APPLICATIONS

This is a Continuation Application of PCT Application No. PCT/JP2004/005252, filed Apr. 13, 2004, which was published under PCT Article 21(2) in Japanese.

This application is based upon and claims the benefit of priority from prior Japanese Patent Application No. 2003-206955, filed Aug. 8, 2003, the entire contents of which are incorporated herein by reference.

### BACKGROUND OF THE INVENTION

1. Field of the Invention

The present invention relates to a doorway door apparatus of a multi-speed type for opening and closing an elevator doorway of an elevator hall.

2. Description of the Related Art

On a wall face of an elevator hall, as shown in FIG. 1, an elevator doorway 2 is formed of a three-way frame 1. At the doorway 2, a door unit 3 for opening and closing the doorway is provided; an operating panel 4 is provided at a lateral portion of the doorway 2; and a cargo call registration button 5 and a display device 6 are provided on the operating panel 4.

The door unit 3 for opening and closing the doorway 2 is generally known to be of a multi-speed type such that a plurality of door panels move at different speeds in one direction to open and close the doorway 2.

In the door unit 3 shown in FIG. 1, two door panels 10a, 10b are used. These door panels 10a, 10b are moved at different speeds in the right direction in FIG. 1 along a threshold 7 by a drive device (such as a electromotive machine, decelerator machine, a pulley, or a geared belt), although not shown, whereby the doorway 2 is opened.

FIG. 2 shows a state in which the door panels 10a, 10b are disposed when they are seen upwardly of the door unit 3. These door panels 10a, 10b are displaced forwardly and backwardly each other and are movably supported in the transverse direction.

The state indicated by the solid line in FIG. 2 is a door closed state. From this state, during door opening, each of the door panels 10a, 10b is driven by the drive device (not shown), and moves in the right direction.

At this time, one door panel 10a moves at a speed which is substantially two times as high as the other door panel 10b. In this manner, the door panels 10a, 10b are stored in a door bag portion 8 in a state in which they are superimposed forwardly and backwardly each other as indicated by the broken line, thereby these door panels are established in a door open state in which the doorway 2 is opened.

From this door open state, each of the door panels 10a, 10b moves in the left direction when they are driven by the drive device (not shown). At this time as well, one door panel 10a moves at a speed which is substantially two times as high as the other door panel 10b, and enters a door closed state. During door closing, one side portion of one door panel 10a and the other side portion of the other door panel 10b enter a state in which they are superimposed forwardly and backwardly each other.

Thus, in the door unit 3 of multi-speed type, a gap of a certain degree is provided to maintain smooth movement performance between one door panel 10a and the other door panel 10b which are adjacent to each other.

In the meantime, in the door unit 3 of double opening type which moves to the left and right when a set of door panels are oriented in an opposite direction to each other in one plane, during the door closing, the side faces between one door panel and the other door panel abut against each other and come into intimate contact with each other. Thus, the air tightness between these panels can be well maintained.

However, as described above, in the door unit 3 of multi-speed type, there is a need for providing a gap of a certain degree in order to maintain smooth movement performance between one door panel 10a and the other door panel 10b which are adjacent to each other. Therefore, during door closing, as shown in FIG. 2, a gap S is produced between the side portion of one door panel 10a and the side portion of the other door panel 10b, making it difficult to maintain the air tightness between these side portions. Thus, there is a problem that the noise in an elevator passage where an elevator cargo moves upwardly and downwardly leaks an elevator hall through the gap S, and noise shutout property is degraded, as shown by the arrow N. In addition, in a case that a fire occurs, there is a problem that a large amount of smoke leaks the elevator hall from the inside of the elevator passage through the gap S.

### BRIEF SUMMARY OF THE INVENTION

It is an object of the present invention to provide an elevator doorway door apparatus capable of enhancing noise shutout property and smoke shutout property while the air tightness between side portions of door panels during door closing is well maintained without degrading the movement performance of the door panels.

According to an embodiment of the present invention, an elevator doorway door apparatus comprises:

door panels displaced forwardly and backwardly each other and movably supported in a transverse direction, the door panels being arranged in an uneven step shape at the left and right during door closing to close a doorway, and moving at different speeds in an identical direction during door opening to open the doorway; and

a closing member provided at a side portion of one of the door panels, the closing member being opposed to a side portion of an adjacent door panel during door closing, and closing a gap between two door panels.

According to another embodiment of the present invention, an elevator doorway door apparatus comprises:

two sets of door panels disposed forwardly and backwardly each other and movably supported in a transverse direction, the door panels being arranged in an uneven step shape at the left and right during door closing to close a doorway, and moving at different speeds in an identical direction during door opening to open the doorway, and door panels being provided as a set such that one set of door panels are arranged symmetrical to another set of door panels at the left and right; and

a closing member provided at a side portion of one of the door panels of each set, the closing member being opposed to a side portion of an adjacent door panel during door closing, and closing a gap between two door panels.

According to another embodiment of the present invention, an elevator doorway door device comprises:

door panels movably supported in a predetermined direction and including one door panel which is lower than another door panel in movement speed during door opening and closing, and

a closing member provided on at least one of the door panels, the closing member closing a gap between the adjacent door panels during door closing,

wherein the one door panel is larger on one side portion and is smaller on the other side portion.

According to another embodiment of the present invention, an elevator doorway door apparatus comprises:

door panels movably supported in a predetermined direction and including one door panel with a high movement speed during door opening and closing and another door panel with a low movement speed; and

a closing member provided on at least one of the door panels, the closing member closing a gap between the adjacent door panels during door closing,

wherein a transverse width L₂ of the one door panel and a transverse width L₁ of the another door panel have a relationship of L₁>L₂.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a perspective view when a conventional elevator doorway door apparatus is seen from the side of an elevator hole;

FIG. 2 is a sectional view of a conventional elevator doorway door apparatus;

FIG. 3 is a sectional view of the apparatus according to a first embodiment of the present invention;

FIG. 4 is a sectional view showing a structure of a mount portion of a closing member in the elevator doorway door apparatus;

FIG. 5 is a front view of the elevator doorway door apparatus;

FIG. 6 is a sectional view of the apparatus according to a second embodiment of the present invention;

FIG. 7 is a sectional view of the apparatus according to a third embodiment of the present invention;

FIG. 8 is a sectional view of the apparatus according to a fourth embodiment of the present invention;

FIG. 9 is a sectional view of the apparatus according to a fifth embodiment of the present invention;

FIG. 10 is a sectional view showing a modified example of the above-described embodiments when a sealing material of the closing member is brought into intimate contact with a side portion of a door panel;

FIG. 11 is a sectional view of the apparatus according to a sixth embodiment of the present invention;

FIG. 12 is a sectional view of the apparatus according to a seventh embodiment of the present invention;

FIG. 13 is a sectional view of the apparatus according to an eighth embodiment of the present invention;

FIG. 14 is a sectional view of the apparatus according to a ninth embodiment of the present invention; and

FIG. 15 is a sectional view of the apparatus according to a tenth embodiment of the present invention.

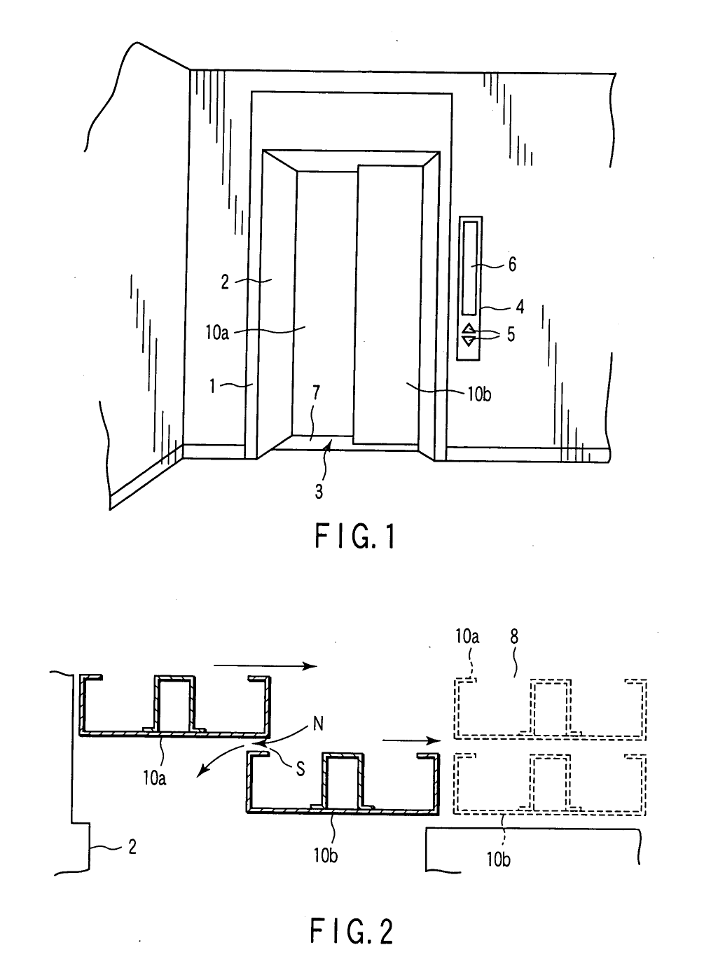

### DETAILED DESCRIPTION OF THE INVENTION

An embodiment of the apparatus according to the present invention will now be described with reference to the accompanying drawings. Like constituent elements corresponding to conventional constituent elements are designated by like reference numerals. A detailed description of these elements is omitted here.

### First Embodiment

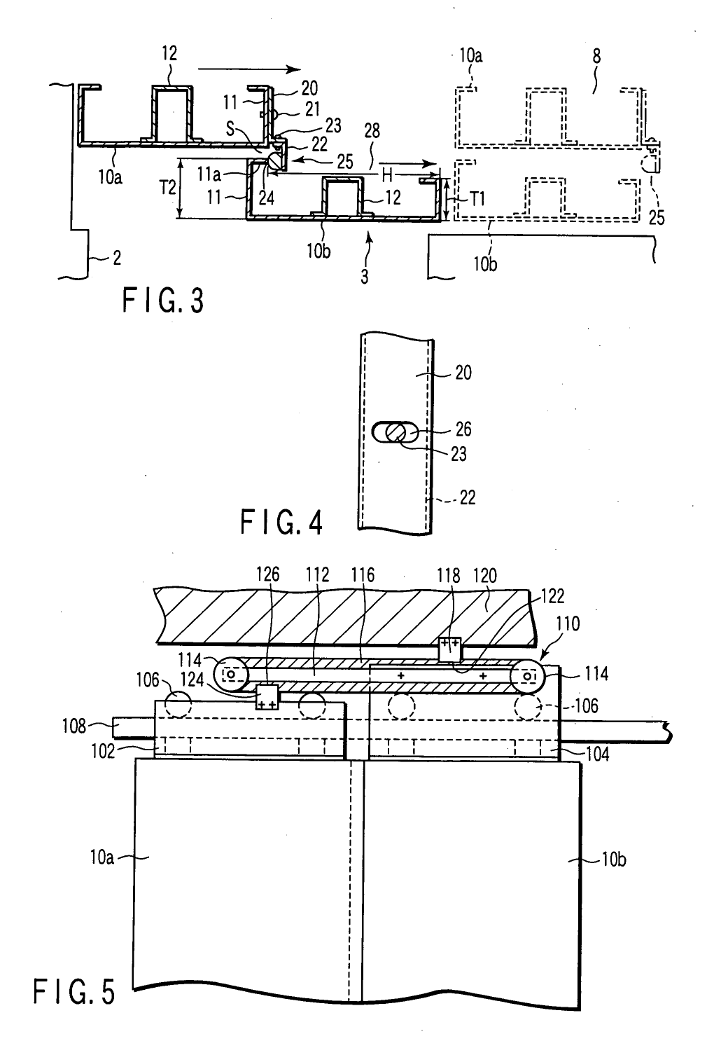

FIGS. 3 to 5 show a first embodiment of the present invention. As shown in FIG. 3, each of door panels 10a, 10b has a side plate 11 which is bent at a substantial right angle on the rear side at the peripheral edge thereof, and further, a bent piece 11a which is inwardly bent at a substantial right angle is formed integrally at an edge portion of the side plate 11. In addition, a reinforcing member 12 is mounted at the rear face of each of the door panels 10a, 10b. The door panel 10a is operated to be opened and closed by means of a drive mechanism (not shown).

A sectional L-shaped mount plate 20 is mounted by a screw 21 at the external face of one side plate 11 on one door panel 10a with a high movement speed, namely, of the side plate 11 facing the side of a door bag portion 8. Further, a sectional L-shaped closing plate 22 is mounted on the mount plate 20 by a screw 23.

The mount plate 20 and the closing plate 22 each have a length which is substantially identical to the height of the door panels 10a, 10b. The closing plate 22 is interposed at the inside of the rear side of the door panel 10b with a low movement speed disposed so as to be opposed to the bent piece 11a of one side plate 11 of the door panel 10b, namely, of the side plate 11 at the opposite side of the door bag portion 8. A sealing material 24 made of an elastic material such as a rubber opposed to the edge portion of the bent piece 11a is mounted on a plate surface of the closing plate 22. The sealing material 24 has a length which is continuous over a substantially full length interval of the height dimension of the closing plate 22, and a closing member 25 is formed of the sealing material 24 and the closing plate 22.

On the mount plate 20, an elongated hole 26 is formed in a transverse direction as shown in FIG. 4; the screw 23 is spirally inserted into the closing plate 22 through the elongated hole 26; and the closing plate 22 is fixed to the mount plate 20 by tightening the screw 23. By loosing the screw 23, the closing plate 22 is moved in a transverse direction along the elongated hole 26. During door closing, a position of the closing plate 22 can be adjusted such that the sealing material 24 properly comes into intimate contact with the edge portion of the bent piece 11a.

As shown in FIG. 5, suspension portions 102, 104 are provided at the upper portions of the door panels 10a, 10b, respectively, and hanger rollers 106 are provided on the back faces of these suspension portions 102, 104. These hanger rollers 106 are placed so as to be rolled on a door rail 108 provided at an elevation port, and the door panels 10a, 10b are suspended on this door rail 108.

On the door panel 10b, an interlock portion 110 for interlocking the door panel 10b during opening and closing of the door panel 10a is provided so as to be locked with the door panel 10a.

At the interlock portion 110, a substrate 112 fixed at the upper portion of the door panel 10b is provided, and a tip end of this substrate 112 protrudes upwardly of the door panel 10a. In addition, pulleys 114 are provided at both ends of the substrate 112, and a loop shaped rope 116 is overhung to be wound around these pulleys 114.

In order to transmit to the door panel 10b a drive force when the door panel 10a is opened and closed via the rope 116, a fixing point 122 fixed to an edge 120 of the elevation port by means of a fixing member 118 is provided at the rope 116, and a moving point 126 fixed to the door panel 10a by a fixing member 124 is also provided at the rope 116.

As a result, in the case where the door panel 10a is moved to be opened and closed, the moving point 126 of the rope 116 moves by identical distance in the same direction as that of the door panel 10a. By moving this moving point 126, the rope 116 rotates while sliding the pulleys 114. On the other hand, this rope 116 is fixed to an edge of the elevation port at the fixing point 122. Thus, when the rope 116 rotates, the door panel 10b itself is interlocked and moved at a speed which is ½ as high as usual in the same direction as that of the door panel 10a via this interlock portion 110 with the fixing point 122 being a fulcrum.

Turning to FIG. 3, on the rear side of the door panel 10b with a low movement speed, a release portion 28 is provided for avoiding mechanical interference between the closing plate 22 and the door panel 10b when the door 10a with a high movement speed moves relative to the door panel 10b with a low movement speed. The release portion 28 is formed by reducing the thickness of the door panel 10b at a portion of an interval H between the bent piece 11a on the door panel 10b and a side face of the door panel 10b at the opposite side of the bent piece 11a, and then, forming a space which enables passing of the closing member 25 on the rear side of the door panel 10b.

That is, with respect to the door panel 10b with a low movement speed, thickness T₁ of a side portion at an opposite side (right side in FIG. 3) of a side which comes into contact with a sealing member 24 of the door panel 10a with a high movement speed is smaller than thickness T₂ of a side portion of a side (left side in FIG. 3) which comes into contact with the sealing member 24 of the door panel 10a with a high movement speed. The release portion 28 is formed of a difference in thickness, enabling passing of the closing member 25 at the rear side of the door panel 10b.

The state indicated by the solid line in FIG. 3 is a door closed state. From this state, during door opening, one door panel 10a moves to the side of the door bag portion 8 in the right direction in FIG. 3 at a high speed, and at the same time, the other door panel 10b moves to the side of the door bag portion 8 in the right direction in FIG. 3 at a low speed.

At this time, the closing plate 22 of one door panel 10a moves relatively the rear side of the other door panel 10b. However, at the side of the door bag portion 8 on the other door panel 10b, the thickness of the release portion 28 and the thickness of the reinforcing member 12 become small, so that the closing member 25 moves without interfering with the door panel 10b. Therefore, the closing member 25 can move smoothly without degrading the movement performance of the door panels 10a, 10b.

By movement of the door panels 10a, 10b in the right direction, the door panels 10a, 10b are stored in a state in which they are superimposed forwardly and backwardly each other at the door bag portion 8 as indicated by the broken line. These door panels 10a, 10b are established in a door open state in which the doorway 2 is opened.

From this door open state, each of the door panels 10a, 10b moves at different speeds in the left direction in FIG. 3. Then, immediately before entering the door closed state, the sealing material 24 of the closing member 25 provided on the door panel 10a elastically abuts against and comes into intimate contact with the edge portion of the bent piece 11a of the door panel 10b.

As has been described above, according to the present embodiment, the gap S between the side portions of the door panels 10a, 10b under the door closed state is sealed with the closing plate 22 and sealing material 24, and the air tightness between these side portions is well maintained. Accordingly, the leakage of noise from an elevation passage to an elevator hall and the leakage of smoke when a fire occurs are suppressed, and the noise shutout property and the smoke shutout property can be enhanced.

The sealing material 24 of the closing member 25 provided on one door panel 10a merely comes into contact with the other door panel 10b only during door closing. During door opening when the door panels 10a, 10b move to the side of the door bag portion 8, the closing member 25 and the door panel 10b enter a non-contact state. Therefore, the door panels 10a, 10b can be moved smoothly without degrading the movement performance of the door panels 10a, 10b during the door opening.

Other embodiments of the elevator doorway door apparatus according to the present invention will be described. The same portions as those of the first embodiment will be indicated in the same reference numerals and their detailed description will be omitted.

### Second Embodiment

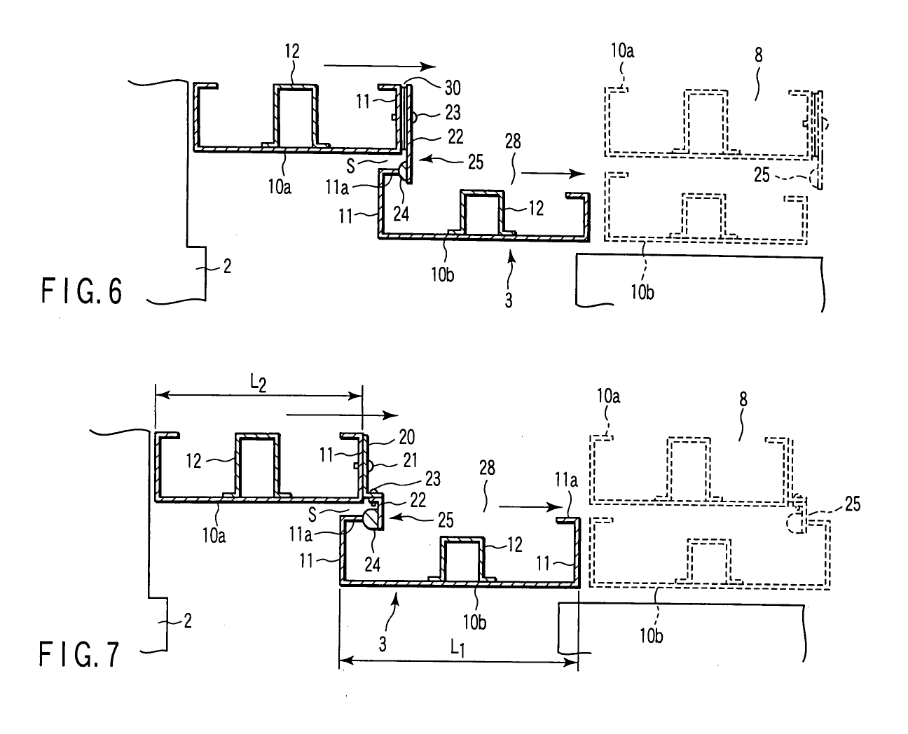

FIG. 6 shows a second embodiment of the present invention. In the second embodiment, on the external face of one side plate 11 on the door panel 10a, a flat closing plate 22 is mounted by the screw 23.

The closing plate 22 has a length which is substantially equal to the height of the door panels 10a, 10b. A part of the closing plate 22 is interposed at the inside of the rear side of the door panel 10b with a low movement speed, and is opposed to a bent piece 11a of a side plate 11 on the door panel 10b. On its opposite face, a sealing material 24 made of an elastic material such as a rubber which abuts against and comes into intimate contact with an edge portion of the bent piece 11a is mounted. The sealing material 24 has a length which is continuous over a substantially full length of the height dimension of the closing plate 22, and a closing member 25 is formed of the sealing material 24 and the closing plate 22.

A required number of shims 30 are interposed between the closing plate 22 and the side plate 11 of the door panel 10a, whereby the sealing material 24 can come into intimate contact with the edge of the bent piece 11a of the door panel 10b during door closing. A required number of shims 30 have an adjusting function. The other constituent elements have the same configuration as that of the first embodiment.

The state indicated by the solid line in FIG. 6 is a door closed state. From this state, during door opening, one door panel 10a moves to the side of the door bag portion 8 in the right direction in FIG. 6 at a high speed, and at the same time, the other door panel 10b moves to the side of the door bag portion 8 in the right direction in FIG. 6 at a low speed.

At this time, the closing member 25 of the door panel 10a moves smoothly without interfering with the door panel 10b through the release portion 28 of the door panel 10b. By movement of the door panels 10a, 10b in the right direction, the door panels 10a, 10b are stored in a state in which they are superimposed forwardly and backwardly each other at the door bag portion 8 as indicated by the broken line. These door panels 10a, 10b are established in a door open state in which the doorway 2 is opened.

From this door open state, during door closing, each of the door panels 10a, 10b moves at different speeds in the left direction in FIG. 6. Then, immediately before entering the door closed state, as shown in the solid line, the sealing material 24 of the door panel 10a elastically abuts against and comes into intimate contact with the edge portion of the bent piece 11a of the door panel 10b.

In this manner, a gap S between the side portions of the door panels 10a, 10b under a door closed state is sealed with the closing plate 22 and the sealing material 24, and the air tightness between these side portions is well maintained. Therefore, the noise shutout property and the smoke shutout property can be enhanced.

### Third Embodiment

FIG. 7 shows a third embodiment of the present invention. In the third embodiment, as is the case with the first embodiment, the sectional L-shaped mount plate 20 is mounted by the screw 21 on the external face of one side plate 11 on the door panel 10a. Further, the sectional L-shaped closing plate 22 is mounted on the mount plate 20 by the screw 23. The sealing material 24 made of an elastic material such as a rubber which abuts against and comes into intimate contact with an edge portion of the bend piece 11a of the door panel 10b is mounted on the closing plate 22. The closing member 25 is formed of these sealing material 24 and closing plate 22.

In the third embodiment, a transverse width L₁ of the door panel 10b with a low movement speed is larger than a transverse width L₂ of the door panel 10a with a high movement speed. When the door panel 10a with a high movement speed moves relatively to the door panel 10b with a low movement speed, the closing member 25 moves at an interval between the bent pieces 11a of the door panel 10b with a low movement speed.

Therefore, the thickness of the reinforcing member 12 of the door panel 10b is reduced so as not to interfere with the closing member 25, thereby making it possible to form the release portion 28 which enables movement of the closing member 25. There is no need for reducing the thickness of the side of the door bag portion 8 of the door panel 10b, and concurrently, manufacturing is facilitated.

In the third embodiment as well, the closing member 25 of the door panel 10a can be moved smoothly without interfering with the reinforcing member 12 of the door panel 10b or the side plate 11 at the side of the door bag portion 8. In addition, under the door closed state, a gap S between the side portions of the door panels 10a, 10b is sealed with the closing plate 22 and sealing material 24; the air tightness between these side portions is well maintained; and the noise shutout property and the smoke shutout property can be enhanced.

### Fourth Embodiment

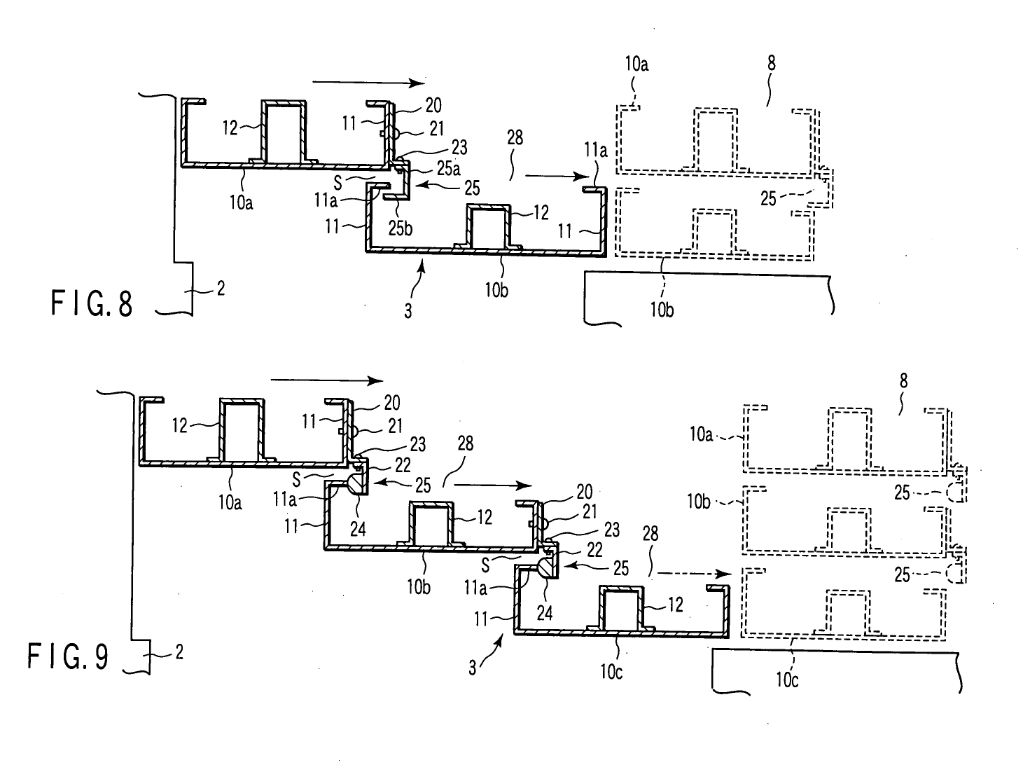

FIG. 8 shows a fourth embodiment of the present invention. In the fourth embodiment, a substantially sectional L-shaped plate material is used as the closing member 25. The closing member 25 has a length which is substantially the same as the height of the door panels 10a, 10b. This closing member 25 is mounted via the mount plate 20 on the side plate 11 at the side of the door bag portion 8 of one door panel 10a.

The closing member 25 is formed in a substantial L shape having a first plate portion 25a parallel to the side plate 11 of the door panel 10b and a second plate portion 25b parallel to the bent piece 11a of the door panel 10b. During door closing, as indicated by the solid line in FIG. 8, the second plate portion 25b advances inside of the bent piece 11a, and is opposed to the bent piece 11a. In this manner, a complex, narrow meandering shape is formed such that a passage going from an elevation passage to an elevator hole through a gap S between the side portions of the door panels 10a, 10b at multiple stages. Thus, the gap S is substantially blocked, making it possible to suppress the leakage of noise from the elevation passage to the elevator hall and the leakage of smoke from the elevation passage to the elevator hall in a case that a fire occurs.

### Fifth Embodiment

In the above-described embodiments, although an elevator doorway door apparatus using two door panels has been shown as an example, for example, it is possible to apply the present invention in the elevator doorway door apparatus using first, second, and third door panels 10a, 10b, 10c as shown as the fifth embodiment in FIG. 9.

In the fifth embodiment, from the door closed state indicated by the solid line, the first door panel 10a, the second door panel 10b, and the third door panel 10c move to the side of the door bag portion 8, respectively, at the highest speed, at the second highest speed, and at a low speed. These door panels 10a, 10b, 10c are stored in the door bag portion 8 to be superimposed each other, as indicated by the broken line. These door panels 10a, 10b, 10c are established in a door open state.

From the door open state, the first door panel 10a, the second door panel 10b, and the third door panel 10c move to the left side, respectively, at the highest speed, at the second highest speed, and at a low speed. These door panels 10a, 10b, 10c are established in a door closed state.

On the external face of the side plate 11 at the side of the door bag portion 8 of the first door panel 10a, the closing member 25 formed of the closing plate 22 and the sealing material 24 is mounted via the mount plate 20.

At the rear side of the door panel 10b, the release portion 28 which enables movement of the closing member 25 is provided. In addition, on the external face of the side plate 11 at the side of the door bad portion 8, the closing member 25 formed of the closing plate 22 and the sealing material 24 is mounted via the mount plate 20.

At the rear side of the third door panel 10c, the release portion 28 which enables movement of the closing member 25 is provided. In addition, on the external face of the side plate 11 at the side of the door bag portion 8, the closing member 25 formed of the closing plate 22 and the sealing material 24 is mounted via the mount plate 20.

During door closing, the sealing material 24 of the closing member 25 of the first door panel 10a abuts against and comes into intimate contact with the bent piece 11a of the side plate 11 of the second door panel 10b. The sealing material 24 of the closing member 25 of the second door panel 10b abuts against and comes into intimate contact with the bent piece 11a of the side plate 11 of the third door panel 10c. In this manner, a gap S between the side portions of the first door panel 10a and the second door panel 10b which are adjacent to each other, and a gap S between the side portions of the second door panel 10b and the third door panel 10c are sealed with the closing member 25, respectively. Therefore, the air tightness between these side portions is well maintained, and the noise shutout property and the smoke shutout property can be enhanced.

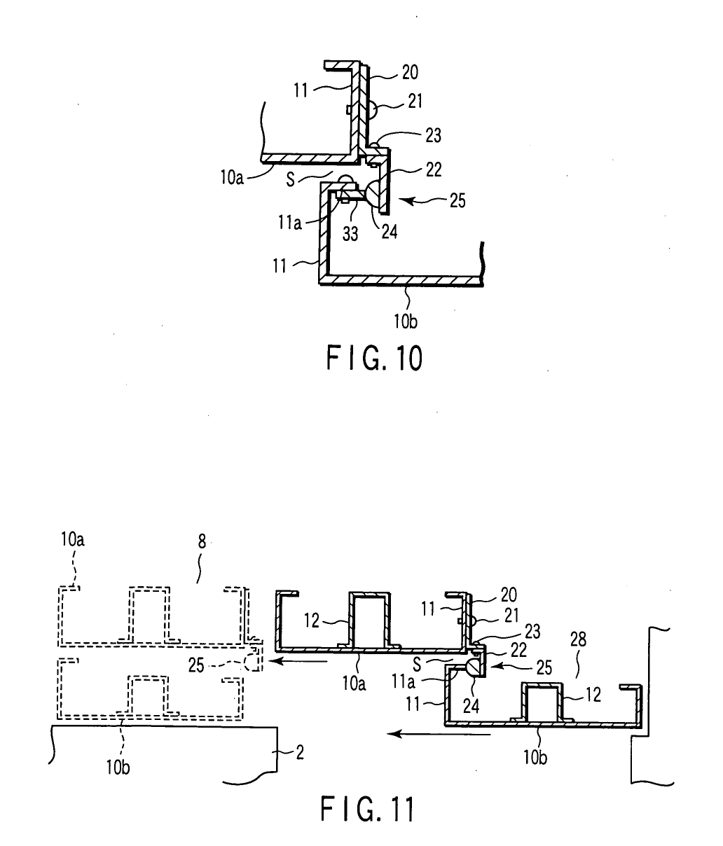

In the above-described first, second, third, and fifth embodiments, the sealing material 24 of the closing member 25 has been brought into direct contact with the bent piece 11a of the side plate 11 of the door panels 10b, 10c. However, as shown in FIG. 10, a receiving member 33 is mounted on the bent piece 11a, and the sealing material 24 of the closing member 25 may be abutted against the receiving member 33 so as to seal the gap S.

### Sixth Embodiment

In the above-embodiments, the closing member 25 has been provided on one door panel with a high movement speed of door panels adjacent to each other. However, as shown as a sixth embodiment of the present invention in FIG. 11, for example, the door bag portion 8 is disposed at the left side of the doorway 2; the door panel 10b moves to the side of the door bag portion 8 at a high speed from a door closed state; and the door panel 10a moves to the side of the door bag portion 8 at a low speed. In the case of this structure, the closing member 25 is mounted on the side portion at the opposite side of the door bag portion 8 of the door panel 10a with a low speed. In this manner, advantageous effect similar to the case of the above-described embodiments can be achieved.

### Seventh Embodiment

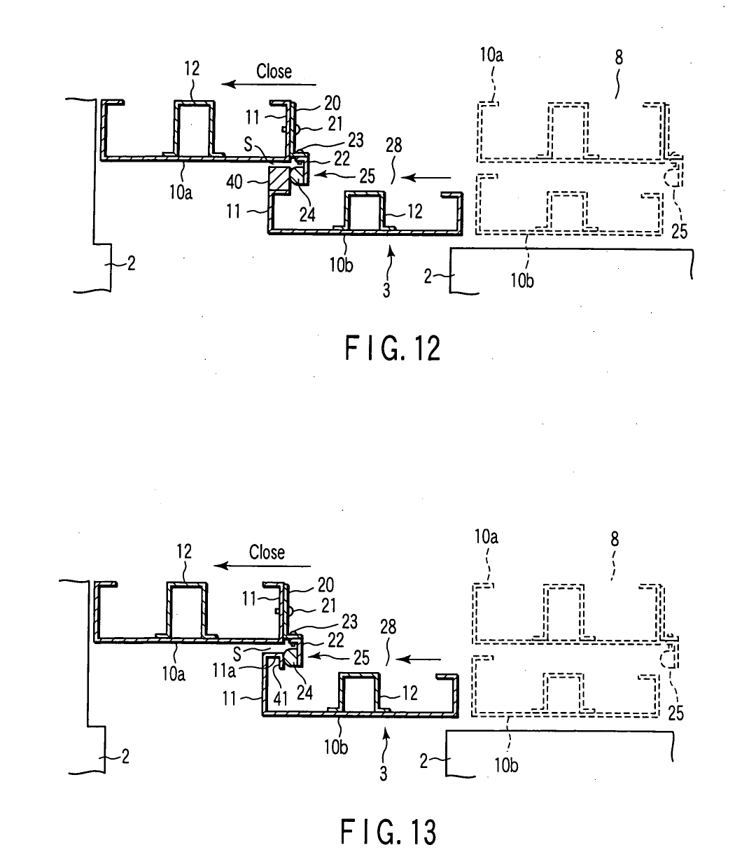

FIG. 12 shows a seventh embodiment of the present invention. In the seventh embodiment, a block member 40 is mounted on the rear of one side portion of the door panel 10b with a low movement speed. The thickness of one side portion of the door panel 10b is substantially large, and the thickness of the other side portion is smaller than that of such one side portion with the block member 40.

During door closing, one door panel 10a having the closing member 25 and the other door panel 10b having the block member 40 move in the left direction in FIG. 12, at a high speed and a low speed, respectively. As indicated by the solid line, the sealing material 24 of the closing member 25 provided on the door panel 10a elastically abuts against and comes into intimate contact with the block member 40 of the door panel 10b. In this manner, under a door closed state, a gap S between the side portions of the door panels 10a, 10b is sealed with the closing plate 22 and the sealing material 24.

In the present embodiment, merely by mounting the block member 40 on the door panel 10b, the thickness of one side portion of the door panel 10b can be substantially larger than that of the other side, so that the present invention can be applied to a variety of door panels.

### Eighth Embodiment

FIG. 13 shows an eighth embodiment of the present invention. In the eighth embodiment, a loopback piece 41 bent to the inside at a substantial right angle is provided integrally at the edge portion of the bent piece 11a at one side portion of the door panel 10b with a low movement speed.

During door closing, one door panel 10a having the closing member 25 and the other door panel 10b having the loopback piece 41 move in the left direction in FIG. 10, respectively, at a high speed and a low speed. As indicated by the solid line, the sealing material 24 of the closing member 25 provided on the door panel 10a elastically comes into planer contact with and comes into intimate contact with a surface of the loopback piece 41 of the door panel 10b. In this manner, under a door closed state, a gap S between the side portions of the door panels 10a, 10b is sealed with the closing plate 22 and the sealing material 24.

In the eighth embodiment, the sealing material 24 of the closing member 25 comes into planar contact with the loopback piece 41 of the door panel 10b. Thus, the sealing property of the gap S can be enhanced, and the damage of the sealing material 24 which comes into contact with the loopback piece 41 repeatedly is prevented over a long period of time, so that its durability can be enhanced.

### Ninth Embodiment

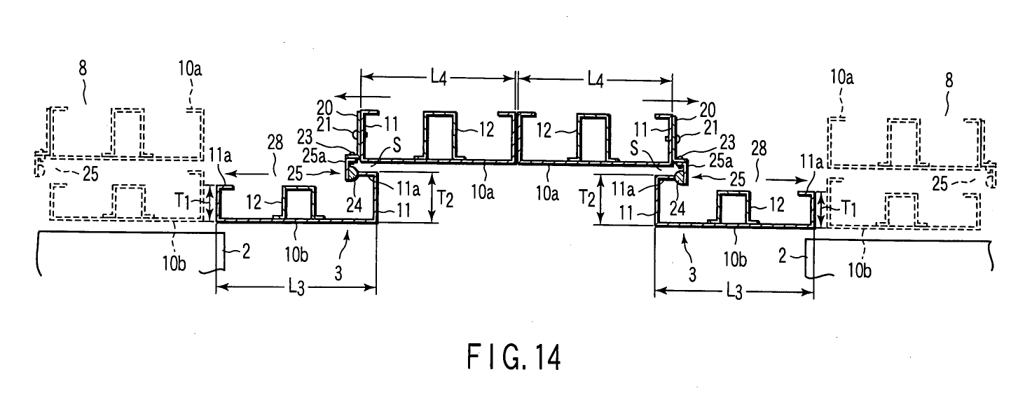

FIG. 14 shows a ninth embodiment of the present invention. In the ninth embodiment, a multi-speed type elevator doorway door apparatus using two door panels 10a and 10b are disposed symmetrically at the left and right, and is provided as a multi-speed double opening type elevator doorway door apparatus. That is, this elevator doorway door apparatus comprises two sets of door panels in which two door panels 10a, 10b are defined as one set, and one set of door panels 10a, 10b and the other set of door panels 10a, 10b are disposed so as to be arranged symmetrically at the left and right each other.

Door panels 10a, 10b of each set are displaced forwardly and backwardly such that the door panel 10a of one set and the door panel 10a of the other set abut against each other during door closing.

One door panel 10a of one set moves at a high speed toward the door bag portion 8 in the right direction in FIG. 11 during door opening, and the other door panel 10b moves at a low speed toward the door bag portion 8 in the right direction. One door panel 10a of the other set moves at a high speed toward the door bag portion 8 in the left direction in FIG. 14, and the other door panel 10b moves at a low speed toward the door bag portion 8 in the left direction. In this manner, a doorway 2 is opened.

During door closing, one door panel 10a of one set moves at a high speed in the left direction, and the other door panel 10b moves at a low speed in the left direction. One door panel 10a of the other set moves at a high speed in the left direction, and the other door panel 10b moves at a low speed in the right direction. In this manner, the doorway 2 is closed.

At the side portions of the door panels 10a of the respective sets with a high speed disposed forward and backwardly to be adjacent to each other, the closing plate 22 and the sealing material 24 are provided as closing members 25. The sealing material 24 serving as the closing member 25 elastically abuts against and comes into contact with an edge portion of the bent piece 11a of the other door panel 10b which is adjacent to the door panel 10a when the door panels 10a, 10b of each set are door closed.

With respect to the door panel 10b with a low movement speed in each set, thickness T₁ of a side portion at an opposite side of a side which comes into contact with the sealing member 24 of the door panel 10a with a high movement speed is smaller than thickness T₂ of a side portion of a side which comes into contact with the sealing member 24 of the door panel 10a with a high movement speed. With this difference in thickness, the closing member 25 can be passed on the rear side of the door panel 10b.

In addition, a gap S between the side portions of the door panels 10a, 10b of each set under a door closed state is sealed with the closing plate 22 and the sealing material 24, whereby the air tightness between the side portions is maintained.

In the embodiment shown in FIG. 14, as in the third embodiment shown in FIG. 7, a transverse width L₃ of the door panel 10b with a low movement speed in each set is set to be greater than a transverse side L₄ of the door panel 10a with a high movement speed (L₃>L₄). When the door panel 10a with a high movement speed moves relatively to the door panel 10b with a low movement speed, it is possible to configure the ninth embodiment such that the closing member 25 can move at an interval between both of the bent pieces 11a of the door panel 10b with a low movement speed.

Further, in the ninth embodiment shown in FIG. 14, as in the seventh embodiment shown in FIG. 12, a block member may be mounted on the rear of one side portion of the door panel 10b with a low movement speed. This makes it possible to form the ninth embodiment such that, with this block member, the thickness of one side portion of the door panel 10b is substantially large, and the thickness of the other side portion of the door panel 10b is smaller than that of such one side portion, and to form the ninth embodiment such that the closing member 25 of the door panel 10a with a high speed comes into contact with the block member during door closing so as to close a gap between the side portions of the door panels 10a, 10b.

Moreover, in the case of the ninth embodiment shown in FIG. 14, as in the eighth embodiment shown in FIG. 13, a loopback piece to be inwardly bent at a substantial right angle may be integrally provided at the edge portion of the bent piece 11a at one side portion of the door panel 10b with a low movement speed. During door closing, the closing member 25 of the door panel 10a with a high speed is elastically brought into planar contact with a surface of the loopback piece, thereby making it possible to form the embodiment so as to seal a gap between the side portions of the door panels 10a, 10b.

### Tenth Embodiment

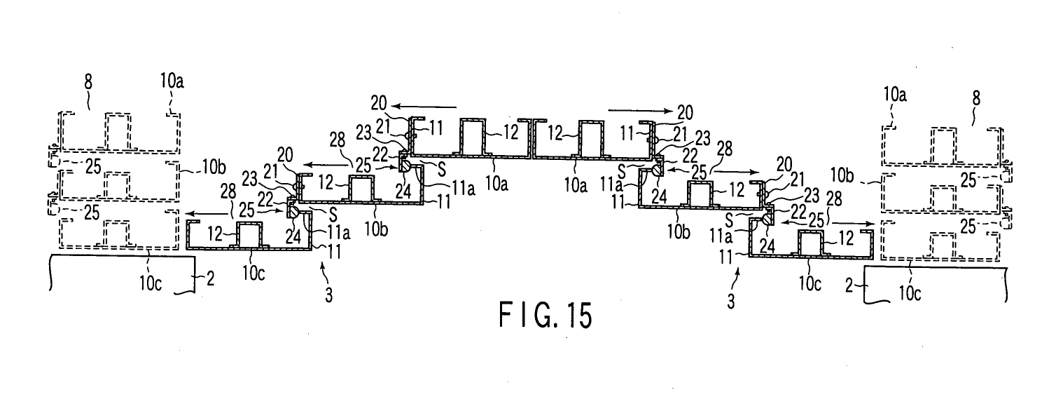

FIG. 15 shows a tenth embodiment of the present invention. In the tenth embodiment, a multi-speed type elevator doorway door apparatus using three door panels 10a, 10a, 10c is disposed symmetrically at the left and right, and is provided as a multi-speed double opening type elevator doorway door apparatus. That is, this elevator doorway door apparatus comprises two sets of door panels in which first, second, and third door panels 10a, 10b, 10c are defined in one set. The door panels 10a, 10b, and 10c of one set and the door panels 10a, lob, 10c of the other set are disposed so as to be arranged symmetrically at the left and right each other.

The door panels 10a, 10b, 10c of each set are displaced forwardly and backwardly such that the first door panel 10a of one set and the first door panel 10a of the other set abut against each other during door closing.

The first door panel 10a of one set moves at the highest speed toward the door bag portion 8 in the right direction in FIG. 15 during door opening, the second door panel 10b moves at the second highest speed toward the door bag portion 8 in the right direction, and the third door panel 10c moves at a low speed toward the door panel portion 8 in the right direction. The first door panel 10a of the other set moves at the highest speed toward the door bag portion 8 in the left direction in FIG. 15 during door opening, the second door panel 10b moves at the second highest speed toward the door bag portion 8 in the left direction, and the third door panel 10c moves at a low speed toward the door bag portion 8 in the left direction. In this manner, the doorway 2 is opened.

During door closing, the first door panel 10a of one set moves at the highest speed in the left direction, the second door panel 10b moves at the second highest speed, and the third door panel 10c moves at a low speed. In addition, the first door panel 10a of the other set moves at the highest speed in the right direction, the second door panel 10b moves at the second highest speed in the right direction, and the third door panel 10c moves at a low speed in the right direction. In this manner, the doorway 2 is closed.

At the side portions of the first and second door panels 10a, 10b of each set disposed forwardly and backwardly to be adjacent to each other, the closing plate 22 and the sealing material 24 are provided as the closing members 25, respectively. The sealing material 24 serving as one of the closing members 25 elastically abuts against and comes into intimate contact with the edge portion of the bent piece 11a of the other door panels 10b, 10c which are adjacent to the door panels 10a, 10b when the door panels 10a, 10b of each set are door closed.

In this manner, under a door closed state, a gap S between the side portions of the door panels 10a, 10b, 10c of each set is sealed with the closing plate 22 and the sealing material 24, and the air tightness between the side portions is maintained.

In any of the above-mentioned embodiments, the closing member 25 for sealing the gap between the side portions of the door panels may be provided on the door panel with a high movement speed without being limited to a case in which it is provided on the door panel with a low movement speed.

Further, the present invention can be applied to an elevator doorway door apparatus of multi-speed one-side opening type for opening and closing a doorway when six door panels move in the same direction at different speeds.

As has been described above, according to the present invention, the air tightness between the side portions of the door panels during door closing is well maintained without degrading the movement performance of the door panels, making it possible to enhance the noise shutout property and the smoke shutout property.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. An elevator doorway door apparatus comprising:
door panels displaced forwardly and backwardly each other and movably supported in a transverse direction, the door panels being arranged in an uneven step shape at the left and right during door closing to close a doorway, and moving at different speeds in an identical direction during door opening to open the doorway; and
a closing member provided at a side portion of one of said door panels, the closing member being opposed to a side portion of an adjacent door panel during door closing, and closing a gap between two door panels.

2. The apparatus according to claim 1, wherein said door panels move toward the side of a door bag portion during door opening.

3. The apparatus according to claim 1, wherein the closing member comprises:
a closing plate mounted on the side portion of the door panel; and
a sealing material mounted on the closing plate, the sealing material abutting against and coming into contact with the side portion of the adjacent door panel during door closing.

4. The apparatus according to claim 3, further comprising an adjustment mechanism which adjusts a position of the closing plate such that the sealing material abuts against and comes into contact with the side portion of the adjacent door panel during door closing.

5. The apparatus according to claim 1, wherein
the one door panel on which the closing member is provided is high in movement speed during door opening and closing; and
the adjacent door panel is lower than the one door panel in movement speed of door opening and closing and comprises a release portion which avoids mechanical interference with the closing member and the adjacent door panel and enables passing of the closing member when the one door panel moves relatively to the adjacent door panel.

6. The apparatus according to claim 1, wherein
the one door panel on which the closing member is provided is high in movement speed during door opening and closing; and
the adjacent door panel is lower than the one door panel in movement speed of door opening and closing, large in thickness of one side portion, and small in thickness of the other side portion.

7. The apparatus according to claim 6, wherein the adjacent door panel comprises a block member which is provided at the one side portion and can come into contact with the closing member of the one door panel.

8. The apparatus according to claim 6, wherein the adjacent door panel comprises a loopback piece which is provided at the one side portion and can come into planar contact with the closing member of the one door panel.

9. The apparatus according to claim 1, wherein
the one door panel on which the closing member is provided is high in movement speed during door opening and closing;
the adjacent door panel is lower than the one door panel in movement speed of door opening and closing; and
a transverse width L₁ of the adjacent door panel and a transverse width L₂ of the one door panel have a relationship of L₁>L₂.

10. An elevator doorway door apparatus comprising:
two sets of door panels disposed forwardly and backwardly each other and movably supported in a transverse direction, the door panels being arranged in an uneven step shape at the left and right during door closing to close a doorway, and moving at different speeds in an identical direction during door opening to open the doorway, and door panels being provided as a set such that one set of door panels are arranged symmetrical to another set of door panels at the left and right; and
a closing member provided at a side portion of one of said door panels of each set, the closing member being opposed to a side portion of an adjacent door panel during door closing, and closing a gap between two door panels.

11. The apparatus according to claim 10, wherein two door panels are provided as a set.

12. The apparatus according to claim 10, wherein three door panels are provided as a set.

13. The apparatus according to claim 10, wherein
the one door panel on which the closing member is provided is high in movement speed during door opening and closing; and
the adjacent door panel is lower than the one door panel in movement speed of door opening and closing, large in thickness of one side portion, and small in thickness of the other side portion.

14. The apparatus according to claim 13, wherein the adjacent door panel comprises a block member which is provided at the one side portion and can come into contact with the closing member of the one door panel.

15. The apparatus according to claim 13, wherein the adjacent door panel comprises a loopback piece which is provided at the one side portion and can come into planar contact with the closing member of the one door panel.

16. The apparatus according to claim 10, wherein
the one door panel on which the closing member is provided is high in movement speed during door opening and closing;
the adjacent door panel is lower than the one door panel in movement speed of door opening and closing; and
a transverse width L₃ of the adjacent door panel and a transverse width L₄ of the one door panel have a relationship of L₃>L₄.

17. An elevator doorway door device comprising:
door panels movably supported in a predetermined direction and including one door panel which is lower than another door panel in movement speed during door opening and closing, and
a closing member provided on at least one of said door panels, the closing member closing a gap between the adjacent door panels during door closing,
wherein the one door panel is larger on one side portion and is smaller on the other side portion.

18. An elevator doorway door apparatus comprising:
door panels movably supported in a predetermined direction and including one door panel with a high movement speed during door opening and closing and another door panel with a low movement speed; and
a closing member provided on at least one of said door panels, the closing member closing a gap between the adjacent door panels during door closing,
wherein a transverse width L₂ of the one door panel and a transverse width L₁ of the another door panel have a relationship of L₁>L₂.
